(19) United States
(12) Patent Application Publication
(10) Pub. No.: US 2013/0006806 A1
(43) Pub. Date: Jan. 3, 2013

(54) METHOD AND APPARATUS FOR APPLICATION COSTING FOR SERVICE PROVISIONING

(75) Inventors: Richard W. German, Carmel, IN (US); Tony E. Thompson, Leo, IN (US)

(73) Assignee: STONEWARE, INC., Indianapolis, IN (US)

(21) Appl. No.: 13/540,121

(22) Filed: Jul. 2, 2012

Related U.S. Application Data
(60) Provisional application No. 61/504,016, filed on Jul. 1, 2011.

(51) Int. Cl. G06Q 30/06

(52) U.S. Cl. 705/26.8

(57) ABSTRACT

Various methods for application costing to provide decision making for service provisioning are provided. One example method may comprise providing for transmission of a request for a service. The method may further comprise receiving a message comprising an ordered list of entries for providing the service. Each entry may comprise requirements. The method may further comprise iteratively evaluating the entries in the order specified by the ordered list. Evaluating a respective entry may comprise determining attributes related to the requirements associated with the respective entry, and evaluating whether the attributes satisfy the requirements. The method may additionally comprise providing for delivery of the service as specified in an entry upon a determination that the attributes satisfy the requirements of the entry. Similar and related example methods, example apparatuses, and example computer program products are also provided.

### CROSS-REFERENCE TO RELATED APPLICATIONS

This application claims priority under 35 USC 119 to U.S. Provisional Application No. 61/504,016 filed Jul. 1, 2011, which is incorporated by reference herein in its entirety.

### TECHNICAL FIELD

Embodiments of the present invention relate generally to application costing, and, more particularly, relate to a method, apparatus, and computer program product for application costing to provide decision making for service provisioning.

### BACKGROUND

The computing industry, over time, has experienced a rapid growth and evolution. Not only have technological advancements led to new models of computing devices, but they have also led to developments in the systems and networks in which the computing devices operate and interact. Each new model of computing device, from mainframes and supercomputers to personal computers and mobile devices, has brought its own share of advantages as well as challenges.

Over the past several decades, computing has been transitioning from distributed systems (e.g. mainframes) to decentralized systems (e.g. personal computers). While the new decentralized, client-oriented personal computer model provided enhanced flexibility and convenience to users, it also resulted in inefficient usage of resources and unnecessary additional costs. For example, each personal computer required the processing power and storage capacity necessary for maximum, rather than typical, loads. As a result, the recent trend in computing has been to a centralized model where applications and data can be centrally managed, stored, and provisioned for the purpose of reducing costs and improving security and efficiency.

One emerging model, known as “the cloud,” relies on the delivery of computing resources via a distributed computer network. In such a model, one or more “servers” in the cloud provide services to one or more distributed “clients.” Services provided by the cloud may range from individual software applications to the full functionality of an operating system. Cloud systems may have drawbacks, however, such as requiring specialty software to be installed on the client device to enable operation. Such specialty software may limit the availability of the cloud services due to lack of compatibility with the client device or a user lacking privileges for installing the software on the client device.

Additionally, the cloud model faces serious challenges in providing these services to end users in a consistent and secure fashion, particularly given the wide variety of devices, hardware, and operating systems employed in client computing systems. In many instances, the configuration and capabilities of the client device may not be considered prior to providing service. For example, some service providers may deliver a particular service to all client devices in the same way regardless of the cost, power demands, memory demands, processor requirements, display requirements, data transmission rates, etc., related to the application and delivery method employed as well as the client device receiving the service. As a result, the content of the service provided as well as the method for delivering the service may not be optimized for the particular client device.

Therefore, a need exists in the art for a computing system that considers the capabilities and configuration of the receiving device when determining the content and delivery method of the services provided.

### SUMMARY

Methods, apparatuses, and computer program products are herein provided for application costing to provide decision making for service provisioning. Systems, methods, apparatuses, and computer program products in accordance with various embodiments may provide several advantages to computing devices, computing device users, and network providers. Various embodiments permit an administrator (e.g., a business enterprise or institution) to create a portal environment system for providing controlled and secure access to a private data center configured specifically for supplying services to a set of clients associated with the administrator (e.g., employees of the business enterprise or institution) on the client's personal device regardless of the client device or client's location.

Some example embodiments advantageously allow an administrator to configure intelligent application delivery objects for delivering a service to a user in a portal environment system. In this regard, an administrator may prioritize the various applications and/or methods for providing a service to attempt to deliver the service in the optimal fashion. As a non-limiting example, an intelligent application delivery object may specify that the best option for delivering a graphics editing service would involve executing a locally installed version of Adobe® Photoshop®. If Adobe® Photoshop® is not installed on the requesting device (i.e., the terminal apparatus), however, the intelligent application delivery object may specify that the next best option is to provide access to Adobe® Photoshop® via a terminal server. In some instances, the terminal server may not be available (e.g., a regularly scheduled anti-virus program may be currently running on the terminal server), in which case the intelligent application delivery object may specify that the third best option is to execute a locally installed version of Microsoft ® Paint ®.

The various embodiments of the present application may allow an administrator to consider numerous preferences when prioritizing the service delivery options including cost (e.g., licensing cost, usage cost, hardware utilization cost), performance (e.g., speed, quality, hardware), user experience, and others. Whereas certain portal environment systems such as Citrix® server always provide services from a data center via a terminal server, embodiments of the present application provide more delivery options and greater flexibility, based on user context and the hardware profile of the requesting device. In some example embodiments, multiple delivery options and alternatives may be attempted in response to a single service request rather than requiring a user to determine and request alternatives if an initial request for service is rejected. Several additional advantages of the various embodiments of the present application will be evident in light of the discussion below.

In an example embodiment, a method is provided, which may comprise providing for transmission of a request for a service. The method of this example embodiment may further comprise receiving a message comprising an ordered list of one or more entries for providing the service. Each entry may comprise one or more requirements associated with the entry. The method of this example embodiment may further comprise iteratively evaluating the one or more entries in the order specified by the ordered list. Evaluating a respective entry according to the method of this example embodiment may comprise determining one or more attributes related to the one or more requirements associated with the respective entry, and evaluating whether the one or more attributes satisfy the one or more requirements associated with the respective entry. The method may additionally comprise providing for delivery of the service as specified in an entry upon a determination that the one or more attributes satisfy the one or more requirements of the entry.

In an example embodiment, a method is provided, which may comprise generating at least one ordered list of one or more entries for providing a respective service. Each entry may comprise one or more requirements associated with the entry. The method of this example embodiment may further comprise receiving a request for a service. The method of this example embodiment may further comprise providing for transmission of an ordered list associated with the requested service. Additionally, the method of this example embodiment may comprise receiving an indication of an entry of the ordered list. The method of this example embodiment may further comprise providing the service as specified in the entry.

### BRIEF DESCRIPTION OF THE DRAWING(S)

Having thus described some example embodiments of the invention in general terms, reference will now be made to the accompanying drawings, which are not necessarily drawn to scale, and wherein:

FIG. 1 illustrates a system for application costing for service provisioning according to some example embodiments of the present invention;

FIG. 2 illustrates a schematic block diagram of a terminal apparatus according to some example embodiments of the present invention;

FIG. 3 illustrates a block diagram of a server according to some example embodiments of the present invention.

FIG. 4 illustrates a block diagram of a relay apparatus according to some example embodiments of the present invention.

FIG. 5 illustrates a flowchart according to an example method for application costing for service provisioning according to some example embodiments of the present invention; and

FIG. 6 illustrates a flowchart according to an example method for application costing for service provisioning according to some example embodiments of the present invention.

### DETAILED DESCRIPTION

Example embodiments of the present invention will now be described more fully hereinafter with reference to the accompanying drawings, in which some, but not all embodiments of the invention are shown. Indeed, the invention may be embodied in many different forms and should not be construed as limited to the embodiments set forth herein; rather, these embodiments are provided so that this disclosure will satisfy applicable legal requirements. Like reference numerals refer to like elements throughout. The terms “data,” “content,” “information,” and similar terms may be used interchangeably, according to some example embodiments of the present invention, to refer to data capable of being transmitted, received, operated on, and/or stored.

Definitions

The term “computer-readable medium” as used herein refers to any medium configured to participate in providing information to a processor, including instructions for execution. Such a medium may take many forms, including, but not limited to a non-transitory computer-readable storage medium (for example, non-volatile media, volatile media), and transmission media. Transmission media include, for example, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization or other physical properties transmitted through the transmission media. Examples of computer-readable media include a floppy disk, a flexible disk, hard disk, magnetic tape, any other magnetic medium, a compact disc read only memory (CD-ROM), compact disc compact disc-rewritable (CD-RW), digital versatile disc (DVD), Blu-Ray, any other optical medium, punch cards, paper tape, optical mark sheets, any other physical medium with patterns of holes or other optically recognizable indicia, a random access memory (RAM), a programmable read only memory (PROM), an erasable programmable read only memory (EPROM), a FLASH-EPROM, any other memory chip or cartridge, a carrier wave, or any other medium from which a computer can read. The term computer-readable storage medium is used herein to refer to any computer-readable medium except transmission media. However, it will be appreciated that where embodiments are described to use a computer-readable storage medium, other types of computer-readable mediums may be substituted for or used in addition to the computer-readable storage medium in alternative embodiments.

As used herein, the term ‘circuitry’ refers to all of the following: (a) hardware-only circuit implementations (such as implementations in only analog and/or digital circuitry); (b) combinations of circuits and software (and/or firmware), such as (as applicable): (i) a combination of processor(s) or (ii) portions of processor(s)/software (including digital signal processor(s)), software, and memory(ies) that work together to cause an apparatus, such as a terminal apparatus, relay, or server, to perform various functions); and (c) circuits, such as a microprocessor(s) or a portion of a microprocessor(s), that require software or firmware for operation, even if the software or firmware is not physically present.

This definition of ‘circuitry’ applies to all uses of this term in this application, including in any claims. As a further example, as used in this application, the term “circuitry” would also cover an implementation of merely a processor (or multiple processors) or portion of a processor and its (or their) accompanying software and/or firmware. The term “circuitry” would also cover, for example and if applicable to the particular claim element, an integrated circuit in a terminal apparatus, relay, server, or other network device.

System

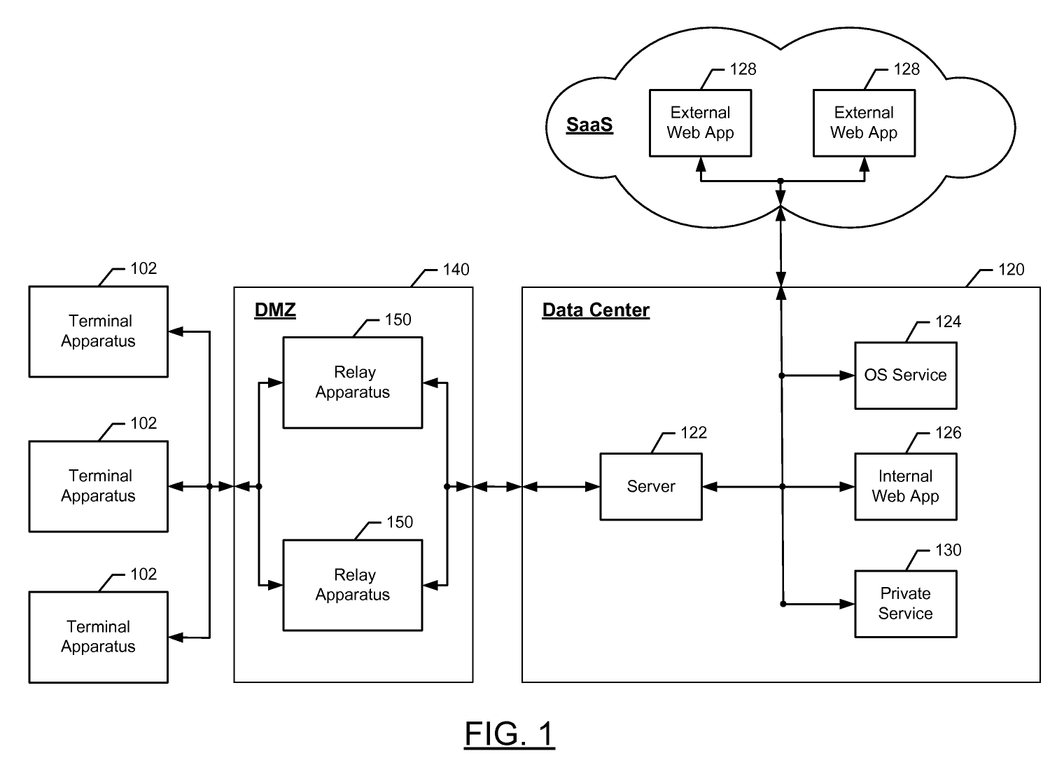

Referring now to FIG. 1, FIG. 1 illustrates a block diagram of a system 100 for providing web-enabled delivery of a data center through a portal interface, such as a desktop built in a browser on a terminal apparatus 102, according to an example embodiment. It will be appreciated that the system 100 as well as the illustrations in other figures are each provided as an example of one embodiment and should not be construed to narrow the scope or spirit of the disclosure in any way. In this regard, the scope of the disclosure encompasses many potential embodiments in addition to those illustrated and described herein. As such, while FIG. 1 illustrates one example of a configuration of a system for providing web-enabled delivery of a data center through a portal interface, numerous other configurations may also be used to implement embodiments of the present invention.

In example embodiments, the system 100 may comprise a data center 120. The data center 120 may be configured to operate as a private cloud, public cloud, or a combination private and public cloud. For example, a public cloud may provide services to any user, whereas a private cloud may provide services to a subset of all users (e.g., employees of a particular business enterprise providing the private cloud services). The data center 120 may, in some instances, be protected by a firewall. In some embodiments, the data center 120 may be located on an internal network such as a private local area network (LAN) or the like, or the data center 120 may be remotely located and/or hosted by a third party. In some instances, the data center 120 may comprise a combination of entities and services residing both locally and remotely.

According to some embodiments, the data center 120 may comprise one or more servers 122. A server 122 may be embodied as any computing device, or in some instances may be embodied as a virtual server. A server 122 may also be embodied as a combination of a plurality of computing devices. In this regard, the server 122 may be embodied, for example, as a server cluster and/or may be embodied as a distributed computing system, which may be distributed across a plurality of computing devices. In other embodiments, one or more servers 122 may be embodied on the same computing device.

According to various embodiments, the system 100 may comprise a demilitarized zone (DMZ) 140 located external to the data center 120. In this regard, the DMZ 140 may be located external to the firewall protecting the data center 120. In example embodiments, the DMZ 140 may comprise one or more relay apparatuses 150. A relay apparatus 150 may be embodied as any computing device, such as, for example, a server computer (e.g. a network web server), desktop computer, laptop computer, or the like. In other embodiments, a relay apparatus 150 may be embodied as a virtual relay. According to some embodiments, the relay apparatuses 150 in the DMZ 140 and the data center 120 may be embodied on the same computing device.

The system 100, according to example embodiments, may comprise one or more terminal apparatuses 102. In various embodiments, the one or more terminal apparatuses 102 may be located external to the DMZ 140 and the data center 120. In this regard, the one or more terminal apparatuses 102 may be located external to the firewall protecting the data center 120. A terminal apparatus 102 may be embodied as any computing device, such as, for example, a desktop computer, laptop computer, netbook, tablet, portable digital assistant (PDA), mobile terminal, mobile computer, mobile phone, mobile communication device, smart phone, game device, television device, digital video recorder, positioning device, any combination thereof, and/or the like.

In certain embodiments, a terminal apparatus 102 may be configured to establish a connection with at least one of the one or more relay apparatuses 150 in the DMZ 140. In some embodiments, a terminal apparatus 102 connected to a first relay apparatus 150 may be transferred to a second relay apparatus 150 during the same session. The connection may be established, for example, over the Internet via a transport protocol such as Transmission Control Protocol (TCP), User Datagram Protocol (UDP), or the like. In these embodiments, the connection may be established via an application-specific protocol such as Hypertext Transfer Protocol (HTTP), Hypertext Transfer Protocol Secure (HTTPS), or the like. The connection may be, in certain embodiments, a secure connection. For example, communication over the connection between the terminal apparatus 102 and the relay apparatus 150 may be secured using Transport Layer Security (TLS), Secure Sockets Layer (SSL), or the like. Data transmitted and received over the connection may be encrypted using, for example, 128 bit SSL encryption.

According to various embodiments, a relay apparatus 150 in the DMZ 140 may be configured to establish a connection with at least one of the one or more servers 122 in the data center 120. For example, a relay apparatus 150 may be configured to establish a pipeline connection with a server 122. The pipeline connection may be configured, in example embodiments, to provide bidirectional communication between the relay apparatus 150 and the server 122. For example, the pipeline connection may be a serial connection, Ethernet connection, socket connection, or the like. The pipeline connection may be, in some embodiments, made through one or more ports, for example through a single port in a firewall protecting the data center 120.

A relay apparatus 150, in example embodiments, may serve as an intermediary between one or more terminal apparatuses 102 and one or more servers 122. In this regard, the relay apparatus 150 may serve as a terminal end point for all communications and requests from the terminal apparatus 102 to the data center 120. The relay apparatus 150 may relay the communications and requests from the terminal apparatus 102 to the server 122. Similarly, the relay apparatus 150 may receive all communications to the terminal apparatus 102 originating from the data center 120 via the pipeline connection with the server 122 and relay the communications to the terminal apparatus 102 via the secure connection. In this regard, the server 122 may be configured to communicate with the applications, file systems, and databases inside the data center 120.

According to various embodiments, the combination of the relay apparatus 150 and the server 122 may provide a two-tier architecture for securing the data center 120 from external users, for example a user at a terminal apparatus 102. In this regard, the relay apparatus 150 may provide a first tier of security for the data center 120 while the server 122 may provide a second tier of security for the data center 120. In other embodiments, a terminal apparatus may be configured to connect directly to the server 122 thereby forming a single tier architecture.

According to some embodiments, the data center 120 may be configured to provide information and services to one or more terminal apparatuses 102 via the architecture described above. Examples of the information and services that may be provided by the data center 120, according to certain embodiments, are described in further detail below.

In some embodiments, the data center 120 may be configured to provide operating system specific services 124. For example, the data center 120 may provide Windows™ applications, such as Word™, Excel™, PowerPoint™, or the like. An operating system specific service 124, in certain embodiments, may be delivered by a publishing method. In this regard, the operating system specific service 124 may be remotely delivered from a terminal server (e.g. Microsoft® Terminal Server) running inside the data center 120. In other embodiments, an operating system specific service 124 may be delivered via an application virtualization method. In this regard, the operating system specific service 124 may be bundled in an executable file and deployed dynamically to a terminal apparatus 102 for local processing. In other embodiments, an operating system specific service 124 may refer to a service or application installed locally at the terminal apparatus and directed to be executed by the data center 120.

In example embodiments, the data center 120 may be configured to provide internally hosted web applications 126. In this regard, the internal web applications 126 may be natively integrated into the data center 120. For example, the internal web applications 126 may comprise web applications configured to run over HTTP, HTTPS, or another similar protocol, such as web servers (e.g. Apache, IIS), web portals (e.g. Microsoft SharePoint®, BEA Weblogic®, IBM Websphere®, Oracle PeopleSoft®, Oracle Financials®), content management systems, web consoles, and/or the like. In some embodiments, the internal web applications 126 may be developed in-house or may be developed by third party vendors.

According to various embodiments, the data center 120 may be configured to provide externally hosted web applications 128. The external web applications 128 may comprise, for example, Software as a Service (SaaS) applications. In certain embodiments, an external web application 128 may be hosted by a third party, for example at a remote data center. For example, the external web applications 128 may comprise applications offered by Salesforce.com™ Google Apps™ Microsoft Live™, Zoho™, Moodle™, and/or the like. An external web application 128 may be delivered to the data center 120 via a trusted connection, for example using Security Assertion Markup Language (SAML), delegated authentication, and/or the like. In this regard, the external web applications 128 may be integrated into the data center 120 for delivery to the terminal apparatuses 102 via the servers 122 and, in certain embodiments, relay apparatuses 150.

In some embodiments, the data center 120 may be configured to provide private services 130, such as cloud services. In this regard, the private services 128 may comprise file services, data services, or the like. The file services, in certain embodiments, may provide access to one or more network file systems, for example shared directories, home directories, public directories, and/or the like. The data services, in example embodiments, may provide access to one or more databases. The databases may in some instances be any Open Database Connectivity (ODBC) or Java Database Connectivity (JDBC) database, such as Microsoft SQL (Structured Query Language) Server®, MySQL™, Oracle Database®, IBM DB2®, Microsoft Access®, and/or the like. The databases may be accessible, for example, by web reporting, electronic web forms, and/or the like.

According to various embodiments, the information and services of the data center 120 may be presented to a client or user of a terminal apparatus 102 via a desktop built in a browser. In this regard, the terminal apparatus 102 may be configured to provide a user with access to a web-enabled browser, for example Microsoft Internet Explorer®, Mozilla Firefox®, Google Chrome®, Opera®, Apple Safari®, and/or the like. In example embodiments, the user may be able to access a desktop using the browser of the terminal apparatus 102. In example embodiments, the desktop may be built on web technologies (e.g. Ajax, Comet, and/or the like) and generated natively at the browser in the terminal apparatus 102. In this regard, the desktop built in a browser may have features similar to a traditional desktop, such as menus, taskbars, desktop icons and background, custom settings, shortcuts, system tray, and/or the like. The desktop provided in the browser may be distinct from a traditional desktop provided by the operating system running on the terminal apparatus 102. Additionally, the desktop built in a browser may be distinct from a virtual presentation of a traditional desktop running at an external location, such as inside the data center 120. In some embodiments, the information and services of the data center 120 may be presented to a user of a terminal apparatus 102 via other portal interfaces, for example, a dashboard, mobile interface, tablet interface, or any other portal interface designed to provide access to one or more data center 120 and/or cloud services. Services and information may, in certain embodiments, be delivered directly to a user without the use of a portal interface.

Terminal Apparatus

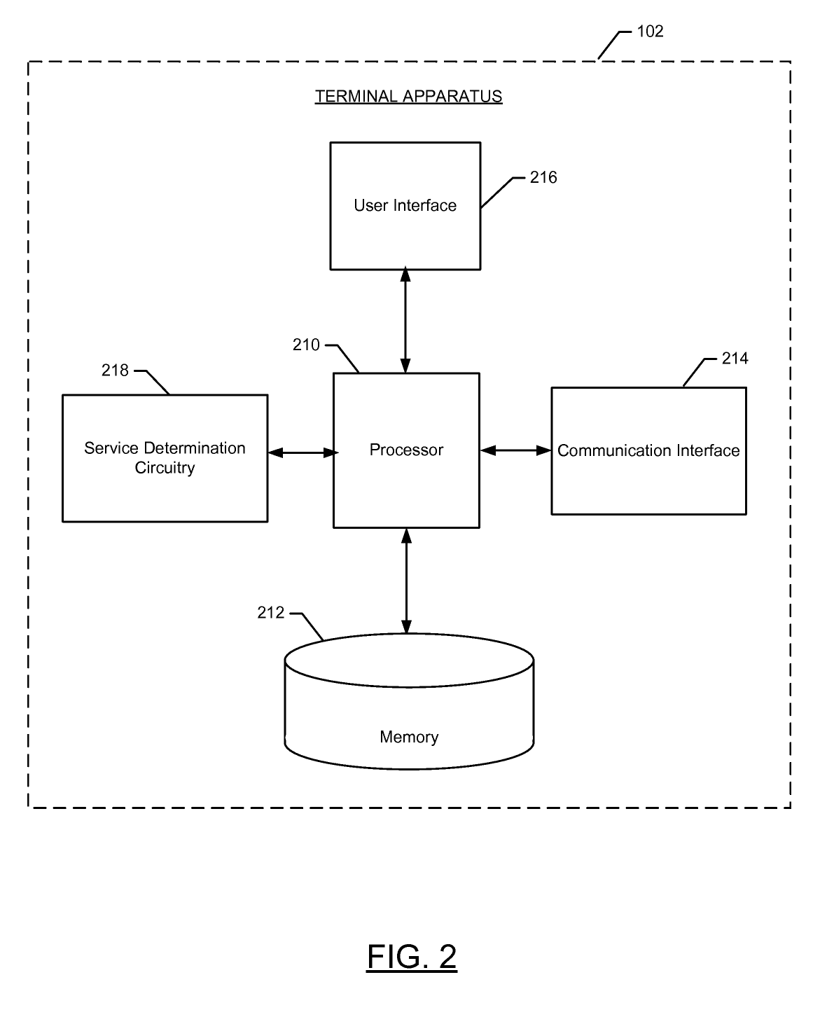

Referring now to FIG. 2, FIG. 2 illustrates a block diagram of a terminal apparatus 102 according to an example embodiment. In the example embodiment, the terminal apparatus 102 comprises various components for performing the various functions herein described. These components may comprise one or more of a processor 210, memory 212, communication interface 214, user interface 216, or service determination circuitry 218. The components of the terminal apparatus 102 as described herein may be embodied as, for example, circuitry, hardware elements (e.g., a suitably programmed processor, combinational logic circuit, and/or the like), a computer program product comprising computer-readable program instructions (e.g., software or firmware) stored on a computer-readable medium (for example memory 212) that is executable by a suitably configured processing device (e.g., the processor 210), or some combination thereof.

In some example embodiments, one or more of the components illustrated in FIG. 2 may be embodied as a chip or chip set. In other words, the terminal apparatus 102 may comprise one or more physical packages (for example, chips) including materials, components and/or wires on a structural assembly (for example, a baseboard). The structural assembly may provide physical strength, conservation of size, and/or limitation of electrical interaction for component circuitry comprised thereon. In this regard, the processor 210, memory 212, communication interface 214, user interface 216, and/or service determination circuitry 218 may be embodied as a chip or chip set. The terminal apparatus 102 may therefore, in some example embodiments, be configured to implement embodiments of the present invention on a single chip or as a single “system on a chip.” As another example, in some example embodiments, the terminal apparatus 102 may comprise component(s) configured to implement embodiments of the present invention on a single chip or as a single “system on a chip.” As such, in some cases, a chip or chipset may constitute components for performing one or more operations for providing the functionalities described herein and/or for enabling user interface navigation with respect to the functionalities and/or services described herein.

The processor 210 may, for example, be embodied as various components including one or more microprocessors, one or more processors, one or more coprocessors, one or more multi-core processors, one or more controllers, processing circuitry, one or more computers, various other processing elements including integrated circuits, or some combination thereof. Accordingly, although illustrated in FIG. 2 as a single processor, in some embodiments the processor 210 comprises a plurality of processors. The plurality of processors may be in operative communication with each other and may be collectively configured to perform one or more functionalities of the terminal apparatus 102 as described herein. The plurality of processors may be embodied on a single client computing device or distributed across a plurality of client computing devices collectively configured to function as the terminal apparatus 102. In some example embodiments, the processor 210 may be configured to execute instructions stored in the memory 212 or otherwise accessible to the processor 210. These instructions, when executed by the processor 210, may cause the terminal apparatus 102 to perform one or more of the functionalities of the terminal apparatus 102 as described herein. As such, whether configured by hardware or software methods, or by a combination thereof, the processor 210 may comprise an entity capable of performing operations according to embodiments of the present invention while configured accordingly. Thus, for example, when the processor 210 is embodied as an executor of instructions, such as may be stored in the memory 212, the instructions may specifically configure the processor 210 to perform one or more algorithms and operations described herein.

The memory 212 may comprise, for example, volatile memory, non-volatile memory, or some combination thereof. In this regard, the memory 212 may comprise one or more tangible and/or non-transitory computer-readable storage media that may comprise volatile and/or non-volatile memory. Although illustrated in FIG. 2 as a single memory, the memory 212 may comprise a plurality of memories. The plurality of memories may be embodied on a single computing device or may be distributed across a plurality of computing devices collectively configured to function as the terminal apparatus 102. In various example embodiments, the memory 212 may comprise a hard disk, random access memory, cache memory, flash memory, a compact disc read only memory (CD-ROM), digital versatile disc read only memory (DVD-ROM), an optical disc, circuitry configured to store information, or some combination thereof. The memory 212 may be configured to store information, data, applications, instructions, or the like for enabling the terminal apparatus 102 to carry out various functions in accordance with various example embodiments. For example, in some example embodiments, the memory 212 is configured to buffer input data for processing by the processor 210. Additionally or alternatively, the memory 212 may be configured to store program instructions for execution by the processor 210. The memory 212 may store information in the form of static and/or dynamic information. This stored information may be stored and/or used by the service determination circuitry 218 during the course of performing its functionalities.

The communication interface 214 may be embodied as any device or component embodied in circuitry, hardware, a computer program product comprising computer readable program instructions stored on a computer readable medium (for example, the memory 212) and executed by a processing device (for example, the processor 210), or a combination thereof that is configured to receive and/or transmit data from/to another computing device. In an example embodiment, the communication interface 214 is at least partially embodied as or otherwise controlled by the processor 210. In this regard, the communication interface 214 may be in communication with the processor 210, such as via a bus. The communication interface 214 may comprise, for example, a network card (e.g. wired or wireless), an antenna, a transmitter, a receiver, and/or supporting hardware or software for enabling communications with one or more remote computing devices. The communication interface 214 may be configured to receive and/or transmit data using any protocol that may be used for communications between computing devices. In this regard, the communication interface 214 may be configured to receive and/or transmit data using any protocol that may be used for transmission of data over a wireless network, wireline network, some combination thereof, or the like by which the terminal apparatus 102 and one or more computing devices or computing resources may be in communication. As an example, the communication interface 214 may be configured to enable communication between the terminal apparatus 102 and another device, such as a relay apparatus 150 or server 122. The communication interface 214 may additionally be in communication with the memory 212, user interface 216, and/or service determination circuitry 218, such as via a bus.

The user interface 216 may be in communication with the processor 210 to receive an indication of a user input and/or to provide an audible, visual, mechanical, or other output to a user. As such, the user interface 216 may comprise, for example, a keyboard, a mouse, a joystick, a display, a touch screen display, a microphone, a speaker, and/or other input/output mechanisms. In embodiments wherein the user interface 216 comprises a touch screen display, the user interface 216 may additionally be configured to detect and/or receive indication of a touch gesture or other input to the touch screen display. The user interface 216 may be in communication with the memory 212, communication interface 214, and/or service determination circuitry 218, such as via a bus.

The service determination circuitry 218 may be embodied as various components, such as circuitry, hardware, a computer program product comprising computer readable program instructions stored on a computer readable medium (for example, the memory 212) and executed by a processing device (for example, the processor 210), or some combination thereof and, in some embodiments, is embodied as or otherwise controlled by the processor 210. In embodiments wherein the service determination circuitry 218 is embodied separately from the processor 210, the service determination circuitry 218 may be in communication with the processor 210. The service determination circuitry 218 may further be in communication with one or more of the memory 212, communication interface 214, or user interface 216, such as via a bus.

According to various embodiments, the service determination circuitry 218 may be configured to receive a request from a user to log on to a portal environment system, such as a web based portal, to gain access to, for example, a data center. The portal interface may be, for example, a desktop in a browser, dashboard, mobile interface, tablet interface, or any other portal interface designed to provide access to one or more data center and/or cloud services. The service determination circuitry 218 may be configured to provide for transmission of a login request to a server 122 associated with the data center, in some instances via a relay apparatus 150. The login request may be, for example, in the form of an HTTP POST command. In example embodiments, prior to transmitting the login request, the service determination circuitry 218 may be configured to determine information related to the user context and/or hardware of the terminal apparatus 102 associated with the service determination circuitry 218. In this regard, the determined user context and/or hardware information may be included in the login request. The user context and/or hardware information may be contained in a text string within the login request, for example, a text string representing a serialized JavaScript Object Notation (JSON) object.

In example embodiments, the service determination circuitry 218 may be configured to receive configuration information for the portal interface from the server 122, in some instances via a relay apparatus 150. The configuration information may indicate one or more services to make available to the user. In this regard, a service may refer to any service or application to which access is provided through the portal environment system, whether located on the terminal apparatus 102 associated with the service determination circuitry 218, in the data center, or on a remote entity. The one or more services indicated may be determined by the server 122 based at least in part on the user context and/or hardware information provided by the service determination circuitry 218. In this regard, if, for example, the hardware information of the terminal apparatus 102 associated with the service determination circuitry 218 does not meet the hardware requirements of a particular service, that service may be restricted and therefore not made available to the user. In certain embodiments, the configuration information may not restrict all services for which the user context and/or hardware requirements are not met at login. In this regard, the configuration information may initially restrict those services whose user context and/or hardware requirements are related to user context and/or hardware information of the terminal apparatus 102 that remains static throughout a session, such as video card type, total installed memory, or the like. The configuration information may not restrict those services whose user context and/or hardware requirements are related to user context and/or hardware information that may change during a session, such as browser type, network connection type, power source, battery charge, or the like.

According to various embodiments, the service determination circuitry 218 may be configured to provide for display of the portal interface to the user. In this regard, the portal interface may comprise a representation of the one or more services indicated by the configuration information sent by the server 122. The portal interface may exclude services and applications restricted by the server 122 based on the user context and/or hardware information. For example, in embodiments where the portal interface is embodied as a desktop in a browser, restricted services and applications may not have associated icons displayed on the desktop or associated start menu.

In certain embodiments, a user may select a service provided by the portal environment system for delivery, for example, by selecting a representation associated with the service from the portal interface (i.e. an icon, menu item, or the like). In some embodiments, the desired service may be stored locally on the terminal apparatus 102 associated with the service determination circuitry 218. The selected representation may be, in some instances, a representation associated with a preconfigured intelligent application delivery object. In this regard, the selected representation may not be associated with a single particular application but rather with an ordered list of a plurality of applications and/or delivery methods for providing the desired service. The service determination circuitry 218 may be configured to provide for transmission to the server 122 of a request for the service or intelligent application delivery object associated with the representation, in some instances via a relay apparatus 150. The request may be configured as, for example, an Asynchronous JavaScript and Extensible Markup Language (XML), or AJAX, request.

According to example embodiments, the service determination circuitry 218 may be configured to receive an intelligent application delivery object associated with the selected representation. In this regard, the intelligent application delivery object may be received by the service determination circuitry 218 from a server 122, in some instances via a relay apparatus 150. The service determination circuitry 218 may be configured to receive the intelligent application delivery objected in the form of, for example, a text string representing a serialized JSON object.

In various embodiments, the intelligent application delivery object may comprise an ordered list including an indication of one or more applications and/or one or more delivery methods for providing the requested service. The ordered list may be a preconfigured list of alternatives for providing the requested service based on one or more preferences. Some preferences may be related to one or more of cost (i.e. licensing cost, usage cost, hardware utilization cost, and/or the like), performance (e.g., speed, quality, and/or the like), user experience, and/or the like. According to certain embodiments, each entry of the ordered list may comprise an application for providing the requested service, a method for delivering the requested service, or both. For example, the first alternative in the ordered list may indicate the first preference for the application and/or method for delivering the requested service; the second alternative in the ordered list may indicate the second preference for the application and/or method for delivering the requested service; and so forth.

According to various embodiments, the service determination circuitry 218 may be configured to evaluate the one or more entries of the ordered list of an intelligent application delivery object. In some embodiments, an entry of the ordered list may comprise one or more conditions and/or requirements related to the application and/or method of delivery associated with the respective entry. The service determination circuitry 218 may be configured to evaluate each entry in order to determine whether the one or more conditions and/or requirements are met. For example, the service determination circuitry 218 may be configured to determine whether an application is installed locally when the method of delivery of an entry relates to local delivery of an application. In an instance in which the conditions and/or requirements of an entry are met, the service determination circuitry 218 may be configured to select the application and/or method of delivery corresponding to the entry for providing the requested service. The service determination circuitry 218, in these embodiments, may terminate the evaluation process once an entry is selected. In an instance in which the conditions and/or requirements of an entry are not met, the service determination circuitry 218 may be configured to reject the entry and evaluate the subsequent entry in the ordered list. The service determination circuitry 218, in these embodiments, may be configured to continue the evaluation process until the conditions and/or requirements of an entry are met, or until all entries have been rejected.

In example embodiments, the one or more conditions and/or requirements may be based at least in part on information related to the terminal apparatus 102 associated with the service determination circuitry 218, for example, user context, hardware information, and/or the like. A requirement may indicate, in certain embodiments, a user context and/or hardware condition necessary to obtain access to the desired service using the application and/or method of delivery associated with a particular entry, for example the requirement may indicate that the terminal apparatus 102 must have a wired connection to the Internet. In other embodiments, a requirement may indicate a user context and/or hardware condition that would lead to restriction of the desired service using the application and/or method of delivery associated with a particular entry, for example the requirement may indicate that the terminal apparatus 102 must not be operating on battery power alone.

In example embodiments, the user context and/or hardware information may be the same as, similar to, or supplementary to the user context and/or hardware information described above with respect to the login request. Some examples of user context information include: time of day, date, operating system type, operating system version, default language, supported languages, browser type, browser version, browser platform, browser platform details, browser window height, browser window width, screen resolution, and/or the like. Various examples of hardware information include: current central processing unit (CPU) utilization, maximum average CPU utilization, chipset, chip support for one time password (OTP), charging status, power source (i.e. battery or power cord), battery charge percentage, battery time remaining, current memory usage, current memory available, total memory installed, available hard drive space, total hard drive space, network bandwidth, network connection type (i.e. wired or wireless), video card model, current screen resolution, maximum screen resolution, supported screen resolutions, mouse availability, keyboard availability, speaker availability, microphone availability, and/or the like.

The following provides various examples of restrictions that may be associated with an entry of an ordered list of an intelligent application delivery object. In a first example embodiment, the entry may comprise an indication of an application for providing the service and an associated user context requirement. For example, the entry may indicate that the application is incompatible with a particular browser type (e.g., Google Chrome®). In a second example embodiment, the entry may comprise an indication of a method for delivering a service and an associated user context requirement. For example, the entry may indicate that delivery of the service via a terminal server is restricted during a certain time of day. In a third example embodiment, the entry may comprise an indication of an application for providing the service and an associated hardware requirement. For example, the entry may indicate that the application requires a minimum installed memory for operation. In a fourth example embodiment, the entry may comprise an indication of a method for delivering a service and an associated hardware requirement. For example, the entry may indicate that delivery of service via application virtualization, such as by dynamically transmitting a bundled executable file to the terminal apparatus 102 for local processing, requires a wired connection to the Internet. It should be appreciated that different requirements as well as combinations of multiple requirements may be associated with an entry according to other embodiments without departing from the scope of the invention.

In some embodiments, the service determination circuitry 218 may be configured to determine if an application specified in an entry is installed locally on the terminal apparatus 102. In this regard, the entry may specify a path or a set of paths for locating the executable file, or other file, of an installed application. For example, the entry may specify that the service determination circuitry 218 search the “Program Files” directory of a Windows® operating system file tree. According to some embodiments, the entry may not provide information on the search location for the installed application and the search location may be determined by the service determination circuitry 218. In certain embodiments, the service determination circuitry 218 may be configured to search for the executable file in the specified path(s) and, in some instances, in the subdirectories of the path(s). The service determination circuitry 218 may be configured to search a specified number of levels into the subdirectories of the path(s). In other embodiments, the service determination circuitry 218 may be configured to search for the application in the registry, system path, or other locations. According to example embodiments, if the location of an installed application is found, the service determination circuitry 218 may provide for storage of the location for future use.

According to various embodiments, the service determination circuitry 218 may be configured to determine user context and/or hardware information related to the terminal apparatus 102 associated with the service determination circuitry 218. In this regard, the service determination circuitry 218 may be configured to determine the particular user context and/or hardware information necessary to evaluate the conditions of the one or more requirements of an entry of an ordered list of an intelligent application delivery object. For example, if a condition for a particular entry requires that the terminal apparatus 102 must have a wired network connection, the service determination circuitry 218 may be configured to determine the network connection status of the terminal apparatus 102.

In example embodiments, the service determination circuitry 218 may be configured to determine the user context information of the terminal apparatus 102 via one or more user context requests. According to certain embodiments, the service determination circuitry 218 may be configured to retrieve user context information via an application programming interface (API) provided by a software development kit (SDK). For example, a user context request may be made via a JavaScript function call, such as from within an Internet browser or a desktop built in a browser portal interface. The service determination circuitry 218 may be configured, in some instances, to retrieve user context information from the User-Agent field of an HTTP request header.

According to various embodiments, the service determination circuitry 218 may be configured to determine the hardware information of the terminal apparatus 102 via one or more hardware information requests. In this regard, the service determination circuitry 218 may be configured to communicate with one or more hardware devices associated with the terminal apparatus 102. The hardware request may occur via an application programming interface (API) provided by a software development kit (SDK) associated with one or more of the hardware devices. For example, a hardware request may be made via a JavaScript function call, for example from within an Internet browser or a desktop built in a browser portal interface. In some embodiments, each hardware request corresponds to a single item of hardware information. In other embodiments, a single hardware request may correspond to more than one item of hardware information.

In some embodiments, the service determination circuitry 218 may be configured to provide for storage of user context and/or hardware information. In this regard, the service determination circuitry 218 may access the stored user context and/or hardware information rather than repeatedly requesting the same information. In other embodiments, the service determination circuitry 218 may be configured to request the information each time to guarantee that the information is current and has not changed since a previous request.

According to example embodiments, the service determination circuitry 218 may be configured to evaluate the conditions of the one or more requirements of an entry of an ordered list of an intelligent application delivery object based at least in part on the determined user context and/or hardware information. In this regard, the service determination circuitry 218 may be configured to compare the user context and/or hardware information of the terminal apparatus 102 associated with the service determination circuitry 218 with the conditions of the one or more requirements associated with a particular entry. In some embodiments, the service determination circuitry 218 may determine that the user context and/or hardware of the terminal apparatus 102 meet the requirements of the entry. In these embodiments, the service determination circuitry 218 may be configured to select the application and/or method of delivery corresponding to the entry for providing the requested service. In other embodiments, the service determination circuitry 218 may determine that the hardware of the terminal apparatus 102 does not meet the requirements of the service. In these embodiments, the service determination circuitry 218 may be configured to reject the entry and evaluate the subsequent entry in the ordered list.

According to some embodiments, the conditions and/or requirements of each entry in the ordered list may not be met. In these instances, the service determination circuitry 218 may be configured to provide an indication to the user that the service is unavailable due to the user context and/or hardware configuration of the terminal apparatus 102. The notification may indicate one or more of the user context and/or hardware requirements not met by the terminal apparatus 102 that led to the unavailability of the service. In some embodiments, one or more requirements may be static conditions that may not be altered during a session with the portal environment system. For example, a requirement may indicate that a particular chipset is necessary for access to the requested service. In this regard, a user may not be able to resolve the issue by changing the chipset of the terminal apparatus 102 during the session. To gain access to the requested service, a user may be required to log out of the session, resolve the issue, and re-attempt to log on. The user may also log out of the session and attempt to log on from a different terminal apparatus 102 configured to meet the conditions and/or requirements of the requested service.

In other embodiments, one or more requirements may not be a static condition, for example, the service may require that the terminal apparatus 102 have a wired network connection or access the service via a particular Internet browser. In these instances, the user may adjust the non-static condition to meet the requirement. In accordance with the example discussed above, the user may establish a wired network connection to the terminal apparatus 102 to meet the wired network connection requirement or switch to the required browser. The user may then provide an indication to the service determination circuitry 218 that the condition has been adjusted to meet the hardware requirement, for example by reselecting a representation associated with the service from the portal interface.

According to various embodiments, the service determination circuitry 218 may be configured to provide for transmission of a report to the server 122 indicating the particular entry for which the terminal apparatus 102 has met all of the conditions and/or requirements associated with the service. In embodiments where the requirements have been met, the report may request that the server 122 allow access to the service via the application and/or method for delivery indicated in the respective entry. In other embodiments where the conditions and/or requirements have not been met for any of the entries, the report may request that the server not provide access to the service.

Server

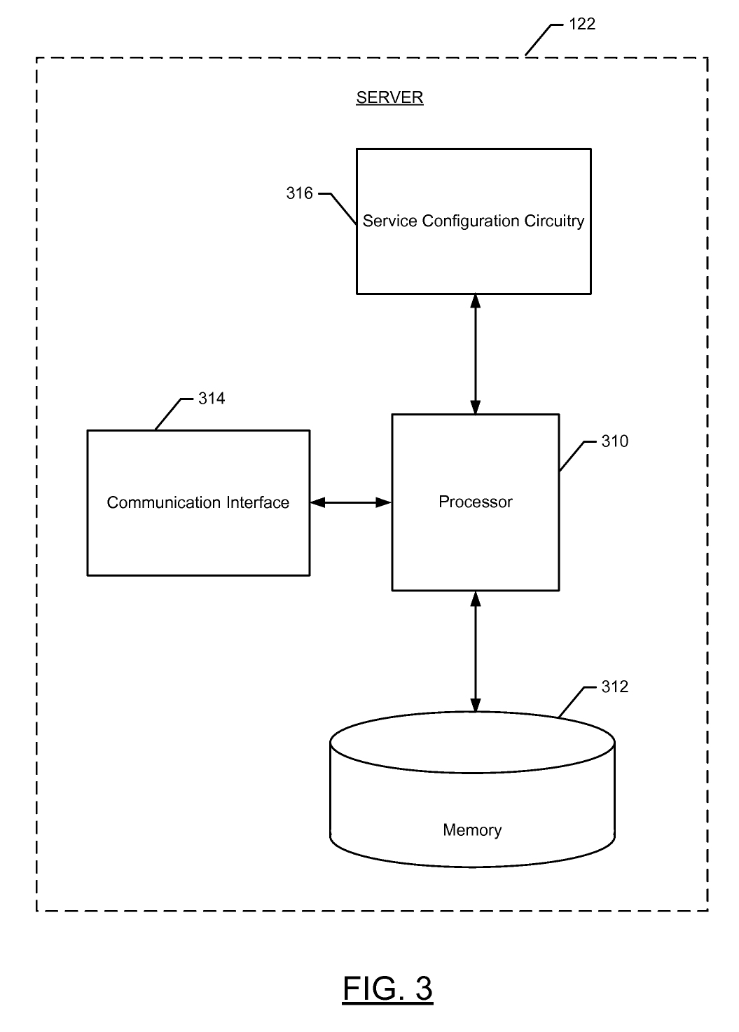

Referring now to FIG. 3, FIG. 3 illustrates a block diagram of a server 122 according to an example embodiment. In the example embodiment, the server 122 comprises various components for performing the various functions herein described. These components may comprise one or more of a processor 310, memory 312, communication interface 314, or service configuration circuitry 316. The components of the server 122 as described herein may be embodied as, for example, circuitry, hardware elements (e.g., a suitably programmed processor, combinational logic circuit, and/or the like), a computer program product comprising computer-readable program instructions (e.g., software or firmware) stored on a computer-readable medium (for example memory 312) that is executable by a suitably configured processing device (e.g., the processor 310), or some combination thereof.

In some example embodiments, one or more of the components illustrated in FIG. 3 may be embodied as a chip or chip set. In other words, the server 122 may comprise one or more physical packages (for example, chips) including materials, components and/or wires on a structural assembly (for example, a baseboard). The structural assembly may provide physical strength, conservation of size, and/or limitation of electrical interaction for component circuitry comprised thereon. In this regard, the processor 310, memory 312, communication interface 314, and/or service configuration circuitry 316 may be embodied as a chip or chip set. The server 122 may therefore, in some example embodiments, be configured to implement embodiments of the present invention on a single chip or as a single “system on a chip.” As another example, in some example embodiments, the server 122 may comprise component(s) configured to implement embodiments of the present invention on a single chip or as a single “system on a chip.” As such, in some cases, a chip or chipset may constitute components for performing one or more operations for providing the functionalities described herein.

The processor 310 may, for example, be embodied as various components including one or more microprocessors, one or more processors, one or more coprocessors, one or more multi-core processors, one or more controllers, processing circuitry, one or more computers, various other processing elements including integrated circuits, or some combination thereof. Accordingly, although illustrated in FIG. 3 as a single processor, in some embodiments the processor 310 comprises a plurality of processors. The plurality of processors may be in operative communication with each other and may be collectively configured to perform one or more functionalities of the server 122 as described herein. The plurality of processors may be embodied on a single computing device or distributed across a plurality of computing devices collectively configured to function as the server 122. In some example embodiments, the processor 310 is configured to execute instructions stored in the memory 312 or otherwise accessible to the processor 310. These instructions, when executed by the processor 310, may cause the server 122 to perform one or more of the functionalities of the server 122 as described herein. As such, whether configured by hardware or software methods, or by a combination thereof, the processor 310 may comprise an entity capable of performing operations according to embodiments of the present invention while configured accordingly. Thus, for example, when the processor 310 is embodied as an executor of instructions, such as may be stored in the memory 312, the instructions may specifically configure the processor 310 to perform one or more algorithms and operations described herein.

The memory 312 may comprise, for example, volatile memory, non-volatile memory, or some combination thereof. In this regard, the memory 312 may comprise one or more tangible and/or non-transitory computer-readable storage media that may comprise volatile and/or non-volatile memory. Although illustrated in FIG. 3 as a single memory, the memory 312 may comprise a plurality of memories. The plurality of memories may be embodied on a single computing device or may be distributed across a plurality of computing devices collectively configured to function as the server 122. In various example embodiments, the memory 312 may comprise a hard disk, random access memory, cache memory, flash memory, a compact disc read only memory (CD-ROM), digital versatile disc read only memory (DVD-ROM), an optical disc, circuitry configured to store information, or some combination thereof. The memory 312 may be configured to store information, data, applications, instructions, or the like for enabling the server 122 to carry out various functions in accordance with various example embodiments. For example, in some example embodiments, the memory 312 is configured to buffer input data for processing by the processor 310. Additionally or alternatively, the memory 312 may be configured to store program instructions for execution by the processor 310. The memory 312 may store information in the form of static and/or dynamic information. This stored information may be stored and/or used by the service configuration circuitry 316 during the course of performing its functionalities.

The communication interface 314 may be embodied as any device or component embodied in circuitry, hardware, a computer program product comprising computer readable program instructions stored on a computer readable medium (for example, the memory 312) and executed by a processing device (for example, the processor 310), or a combination thereof that is configured to receive and/or transmit data from/to another computing device. In an example embodiment, the communication interface 314 is at least partially embodied as or otherwise controlled by the processor 310. In this regard, the communication interface 314 may be in communication with the processor 310, such as via a bus. The communication interface 314 may comprise, for example, a network card (e.g. wired or wireless), an antenna, a transmitter, a receiver, and/or supporting hardware or software for enabling communications with one or more remote computing devices. The communication interface 314 may be configured to receive and/or transmit data using any protocol that may be used for communications between computing devices. In this regard, the communication interface 314 may be configured to receive and/or transmit data using any protocol that may be used for transmission of data over a wireless network, wireline network, some combination thereof, or the like by which the server 122 and one or more computing devices or computing resources may be in communication. As an example, the communication interface 314 may be configured to enable communication between the server 122 and another device, such as a relay apparatus 150 or terminal apparatus 102. The communication interface 314 may additionally be in communication with the memory 312 and/or service configuration circuitry 316, such as via a bus.

The service configuration circuitry 316 may be embodied as various components, such as circuitry, hardware, a computer program product comprising computer readable program instructions stored on a computer readable medium (for example, the memory 312) and executed by a processing device (for example, the processor 310), or some combination thereof and, in some embodiments, is embodied as or otherwise controlled by the processor 310. In embodiments wherein the service configuration circuitry 316 is embodied separately from the processor 310, the service configuration circuitry 316 may be in communication with the processor 310. The service configuration circuitry 316 may further be in communication with one or more of the memory 312 and/or communication interface 314, such as via a bus.

According to various embodiments, the service configuration circuitry 316 may be configured to generate one or more intelligent application delivery objects. In this regard, the service configuration circuitry 316 may provide, in certain embodiments, an interface so that a user or administrator may configure the intelligent application delivery objects. Each of the one or more intelligent application delivery objects may comprise an ordered list of one or more entries, such that each entry provides an indication of an application and/or delivery method for providing a particular service. In some embodiments, each entry may comprise one or more conditions and/or requirements that must be met before providing the service using the application and/or delivery method indicated in the entry. The service configuration circuitry 316 may be configured to prioritize, or allow an administrator to prioritize (e.g., via an interface), the one or more entries in the ordered list according to various preferences. According to example embodiments, the service configuration circuitry 316 may be configured to provide for storage of the one or more intelligent application delivery objects, for example in a Lightweight Directory Access Protocol (LDAP) directory.

The service configuration circuitry 316, in some embodiments may be configured to associate one or more configuration options with each of the one or more entries of a particular intelligent application delivery object. For example, a configuration option may indicate whether to provide the associated application natively or within the portal environment system (e.g., a desktop within a browser), the size (i.e. height and width) of the window for providing the service, the location of the window for providing the service, and/or the like.

In some embodiments, the service configuration circuitry 316 may be configured to receive a request from a terminal apparatus 102 for a user to log on to a web based portal provided by the server 122 associated with the service configuration circuitry 316. In certain embodiments, the login request may comprise user context and/or hardware information about the terminal apparatus 102. In example embodiments, the service configuration circuitry 316 may be configured to provide for storage of the user context and/or hardware information associated with the terminal apparatus 102. The service configuration circuitry 316 may provide for transmission of configuration information for the web based portal interface to the terminal apparatus 102, in some instances via a relay apparatus 150. The configuration information may indicate one or more services and/or intelligent application delivery objects to make available to the user. In this regard, a service may refer to any service or application to which access is provided through the portal environment system, whether located on the terminal apparatus 102, in the data center, or on a remote entity.

According to various embodiments, the one or more services and/or intelligent application delivery objects indicated may be determined by the service configuration circuitry 316 based at least in part on the user context and/or hardware information provided in the login request. In this regard, in an instance in which the hardware information of the terminal apparatus 102, for example, does not meet the hardware requirements of a particular service, that service may be restricted and therefore not made available to the user. Similarly, in certain embodiments, any entry in an intelligent application delivery object associated with a restricted application and/or delivery method for a service may be removed or marked for omission in the intelligent application delivery object. In other embodiments, a intelligent application delivery object may not be altered in response to a login request.

In certain embodiments, the service configuration circuitry 316 may not restrict all services and/or entries in intelligent application delivery objects for which the user context and/or hardware requirements are not met at login. In this regard, the service configuration circuitry 316 may initially restrict those services and/or entries whose user context and/or hardware requirements are related to user context and/or hardware information of the terminal apparatus 102 that remains static throughout a session, such as video card type, total installed memory, or the like. The service configuration circuitry 316 may not restrict those services and/or entries whose user context and/or hardware requirements are related to user context and/or hardware information that may change during a session, such as browser type, network connection type, power source, or the like.

According to various embodiments, the service configuration circuitry 316 may be configured to receive a request for a service from a terminal apparatus 102. In some embodiments, the service may be requested via an intelligent application delivery object. In this regard, the request may be received, in example embodiments, in response to a user requesting a particular intelligent application delivery object at the terminal apparatus 102, such as via a representation (e.g., an icon or menu item) associated with an intelligent application delivery object displayed on a portal interface. In example embodiments, the service request may comprise user context and/or hardware information about the terminal apparatus 102.

The service configuration circuitry 316, in certain embodiments, may retrieve the intelligent application delivery object associated with the service request. In instances where the service configuration circuitry 316 has not previously evaluated the one or more requirements of the entries in the intelligent application delivery object during login or where the service request comprises user context and/or hardware information, the service configuration circuitry 316 may be configured to evaluate the requirements of each of the entries based at least in part on the user context and/or hardware information provided by the terminal apparatus 102. In this regard, the service configuration circuitry 316 may be configured to remove, or mark for omission, the one or more entries for which the user context and/or hardware information do not meet the requirements. According to other embodiments, the service configuration circuitry 316 may not further evaluate the requirements of the entries of the intelligent application delivery object. In some embodiments, the service configuration circuitry 316 may be configured to retrieve the user context and/or hardware information from storage and evaluate the entries of the intelligent application delivery object.

In example embodiments, the service configuration circuitry 316 may be configured to provide for transmission of the intelligent application delivery object associated with the requested service to the terminal apparatus 102. In this regard, the intelligent application delivery object may be contained in a text string, for example, a text string representing a serialized JavaScript Object Notation (JSON) object. The representation of the intelligent application delivery object may or may not comprise the entries for which the user context and/or hardware information of the terminal apparatus 102 known by the service configuration circuitry 316 are not met.

According to various embodiments, the service configuration circuitry 316 may be configured to receive an indication of the application and/or method for delivery of the requested service from the terminal apparatus 102. For example, the service configuration circuitry 316 may receive a message from the terminal apparatus 102 indicating the entry of the intelligent application delivery object comprising the application and/or method for delivery of the service. The service configuration circuitry 316 may, in example embodiments, deliver the service to the terminal apparatus 102 in the manner indicated by the entry, or, in instances where the service has previously been delivered or is locally available at the terminal apparatus 102, provide for transmission of a message to the terminal apparatus 102 authorizing access to the service. In embodiments where the user context and/or hardware requirements are not met for any of the entries of the intelligent application delivery object, the service configuration circuitry 316 may be configured not to provide for delivery of the requested service.

Relay Apparatus

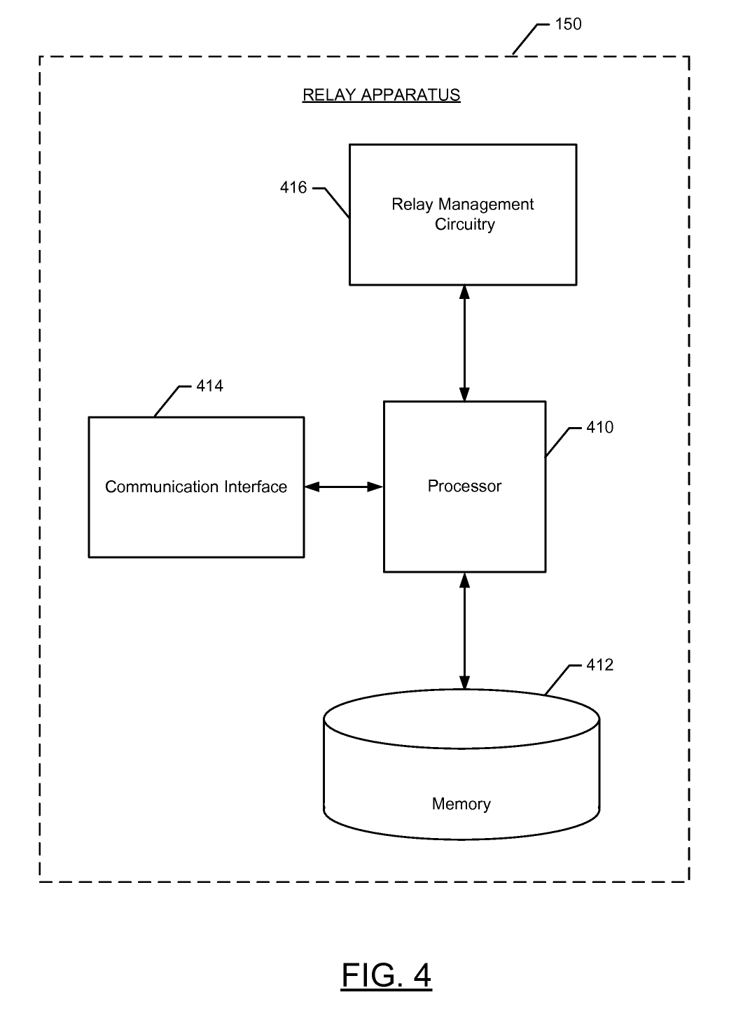

Referring now to FIG. 4, FIG. 4 illustrates a block diagram of a relay apparatus 150 according to an example embodiment. In the example embodiment, the relay apparatus 150 comprises various components for performing the various functions herein described. These components may comprise one or more of a processor 410, memory 412, communication interface 414, or relay management circuitry 416. The components of the relay apparatus 150 as described herein may be embodied as, for example, circuitry, hardware elements (e.g., a suitably programmed processor, combinational logic circuit, and/or the like), a computer program product comprising computer-readable program instructions (e.g., software or firmware) stored on a computer-readable medium (for example memory 412) that is executable by a suitably configured processing device (e.g., the processor 410), or some combination thereof.

In some example embodiments, one or more of the components illustrated in FIG. 4 may be embodied as a chip or chip set. In other words, the relay apparatus 150 may comprise one or more physical packages (for example, chips) including materials, components and/or wires on a structural assembly (for example, a baseboard). The structural assembly may provide physical strength, conservation of size, and/or limitation of electrical interaction for component circuitry comprised thereon. In this regard, the processor 410, memory 412, communication interface 414, and/or relay management circuitry 416 may be embodied as a chip or chip set. The relay apparatus 150 may therefore, in some example embodiments, be configured to implement embodiments of the present invention on a single chip or as a single “system on a chip.” As another example, in some example embodiments, the relay apparatus 150 may comprise component(s) configured to implement embodiments of the present invention on a single chip or as a single “system on a chip.” As such, in some cases, a chip or chipset may constitute components for performing one or more operations for providing the functionalities described herein.

The processor 410 may, for example, be embodied as various components including one or more microprocessors, one or more processors, one or more coprocessors, one or more multi-core processors, one or more controllers, processing circuitry, one or more computers, various other processing elements including integrated circuits, or some combination thereof. Accordingly, although illustrated in FIG. 4 as a single processor, in some embodiments the processor 410 comprises a plurality of processors. The plurality of processors may be in operative communication with each other and may be collectively configured to perform one or more functionalities of the relay apparatus 150 as described herein. The plurality of processors may be embodied on a single computing device or distributed across a plurality of computing devices collectively configured to function as the relay apparatus 150. In some example embodiments, the processor 410 is configured to execute instructions stored in the memory 412 or otherwise accessible to the processor 410. These instructions, when executed by the processor 410, may cause the relay apparatus 150 to perform one or more of the functionalities of the relay apparatus 150 as described herein. As such, whether configured by hardware or software methods, or by a combination thereof, the processor 410 may comprise an entity capable of performing operations according to embodiments of the present invention while configured accordingly. Thus, for example, when the processor 410 is embodied as an executor of instructions, such as may be stored in the memory 412, the instructions may specifically configure the processor 410 to perform one or more algorithms and operations described herein.

The memory 412 may comprise, for example, volatile memory, non-volatile memory, or some combination thereof. In this regard, the memory 412 may comprise one or more tangible and/or non-transitory computer-readable storage media that may comprise volatile and/or non-volatile memory. Although illustrated in FIG. 4 as a single memory, the memory 412 may comprise a plurality of memories. The plurality of memories may be embodied on a single computing device or may be distributed across a plurality of computing devices collectively configured to function as the relay apparatus 150. In various example embodiments, the memory 412 may comprise a hard disk, random access memory, cache memory, flash memory, a compact disc read only memory (CD-ROM), digital versatile disc read only memory (DVD-ROM), an optical disc, circuitry configured to store information, or some combination thereof. The memory 412 may be configured to store information, data, applications, instructions, or the like for enabling the relay apparatus 150 to carry out various functions in accordance with various example embodiments. For example, in some example embodiments, the memory 412 is configured to buffer input data for processing by the processor 410. Additionally or alternatively, the memory 412 may be configured to store program instructions for execution by the processor 410. The memory 412 may store information in the form of static and/or dynamic information. This stored information may be stored and/or used by the relay management circuitry 416 during the course of performing its functionalities.

The communication interface 414 may be embodied as any device or component embodied in circuitry, hardware, a computer program product comprising computer readable program instructions stored on a computer readable medium (for example, the memory 412) and executed by a processing device (for example, the processor 410), or a combination thereof that is configured to receive and/or transmit data from/to another computing device. In an example embodiment, the communication interface 414 is at least partially embodied as or otherwise controlled by the processor 410. In this regard, the communication interface 414 may be in communication with the processor 410, such as via a bus. The communication interface 414 may comprise, for example, a network card (e.g. wired or wireless), an antenna, a transmitter, a receiver, and/or supporting hardware or software for enabling communications with one or more remote computing devices. The communication interface 414 may be configured to receive and/or transmit data using any protocol that may be used for communications between computing devices. In this regard, the communication interface 414 may be configured to receive and/or transmit data using any protocol that may be used for transmission of data over a wireless network, wireline network, some combination thereof, or the like by which the relay apparatus 150 and one or more computing devices or computing resources may be in communication. As an example, the communication interface 414 may be configured to enable communication between the relay apparatus 150 and another device, such as a terminal apparatus 102 or server 122. The communication interface 414 may additionally be in communication with the memory 412 and/or relay management circuitry 416, such as via a bus.

The relay management circuitry 416 may be embodied as various components, such as circuitry, hardware, a computer program product comprising computer readable program instructions stored on a computer readable medium (for example, the memory 412) and executed by a processing device (for example, the processor 410), or some combination thereof and, in some embodiments, is embodied as or otherwise controlled by the processor 410. In embodiments wherein the relay management circuitry 416 is embodied separately from the processor 410, the relay management circuitry 416 may be in communication with the processor 410. The relay management circuitry 416 may further be in communication with one or more of the memory 412 and/or communication interface 414, such as via a bus.

According to various embodiments, the relay management circuitry 416 may be configured to relay information between a first entity, for example a terminal apparatus 102, and a second entity, for example a server 122. In this regard, the relay management circuitry 416 may be configured to receive communications from a terminal apparatus 102 that are intended for a server 122. The relay management circuitry 416 may provide for transmission of the received communications to the server 122. Similarly, the relay management circuitry 416 may be configured to receive communications from the server 122 intended for the terminal apparatus 102 and to send the communications to the terminal apparatus 102.

### EXAMPLES

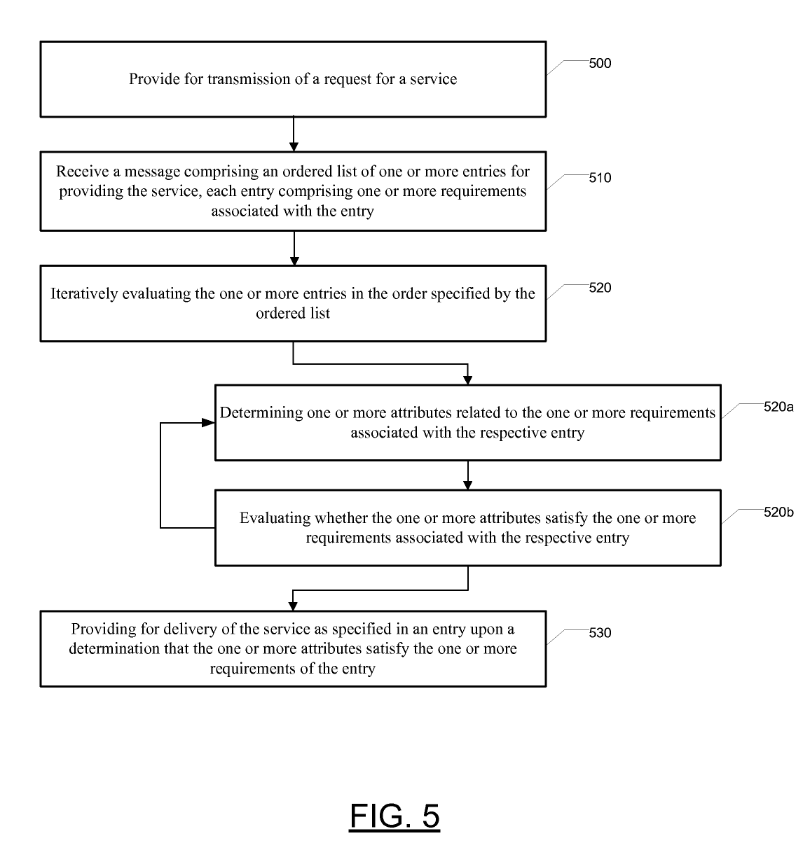

FIG. 5 illustrates a flowchart according to an example method for application costing to provide decision making for service provisioning according to an example embodiment. In this regard, FIG. 5 illustrates operations that may be performed at a terminal apparatus 102. The operations illustrated in and described with respect to FIG. 5 may, for example, be performed by, with the assistance of, and/or under the control of the processor 210, memory 212, communication interface 214, user interface 216, or service determination circuitry 218. Operation 500 may comprise providing for transmission of a request for a service. The processor 210, memory 212, communication interface 214, user interface 216, or service determination circuitry 218 may, for example, provide structure for performing operation 500. Operation 510 may comprise receiving a message comprising an ordered list of one or more entries for providing the service. Each entry may comprise one or more requirements associated with the entry. The processor 210, memory 212, communication interface 214, user interface 216, or service determination circuitry 218 may, for example, provide structure for performing operation 510. Operation 520 may comprise iteratively evaluating the one or more entries in the order specified by the ordered list. Evaluating a respective entry may comprise determining one or more attributes related to the one or more requirements associated with the respective entry, as shown in operation 520a, and evaluating whether the one or more attributes satisfy the one or more requirements associated with the respective entry, as shown in operation 520b. The processor 210, memory 212, communication interface 214, user interface 216, or service determination circuitry 218 may, for example, provide structure for performing operations 520, 520a, and 520b. Operation 530 may comprise providing for delivery of the service as specified in an entry upon a determination that the one or more attributes satisfy the one or more requirements of the entry. The processor 210, memory 212, communication interface 214, user interface 216, or service determination circuitry 218 may, for example, provide structure for performing operation 530.

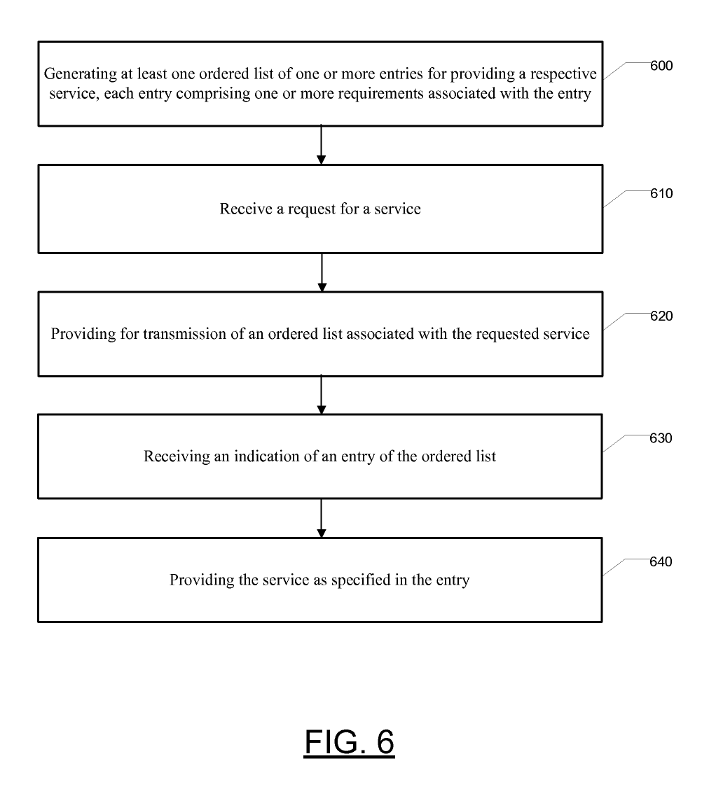

FIG. 6 illustrates a flowchart according to another example method for application costing for service provisioning according to an example embodiment. In this regard, FIG. 6 illustrates operations that may be performed at a server 122. The operations illustrated in and described with respect to FIG. 6 may, for example, be performed by, with the assistance of, and/or under the control of one or more of the processor 310, memory 312, communication interface 314, or service configuration circuitry 316. Operation 600 may comprise generating at least one ordered list of one or more entries for providing a respective service. Each entry may comprise one or more requirements associated with the entry. The processor 310, memory 312, communication interface 314, or service configuration circuitry 316 may, for example, provide structure for performing operation 600. Operation 610 may comprise receiving a request for a service. The processor 310, memory 312, communication interface 314, or service configuration circuitry 316 may, for example, provide structure for performing operation 610. Operation 620 may comprise providing for transmission of an ordered list associated with the requested service. The processor 310, memory 312, communication interface 314, or service configuration circuitry 316 may, for example, provide structure for performing operation 620. Operation 630 may comprise receiving an indication of an entry of the ordered list. The processor 310, memory 312, communication interface 314, or service configuration circuitry 316 may, for example, provide structure for performing operation 630. Operation 640 may comprise providing the service as specified in the entry. The processor 310, memory 312, communication interface 314, or service configuration circuitry 316 may, for example, provide structure for performing operation 640.

FIGS. 5-6 each illustrate a flowchart of a system, method, and computer program product according to example embodiments of the invention. It will be understood that each block of the flowchart, and combinations of blocks in the flowchart, may be implemented by various means, such as hardware and/or a computer program product comprising one or more computer-readable mediums (as opposed to a computer-readable transmission medium which describes a propagating signal) having one or more computer program code instructions, program instructions, or executable computer-readable program code instructions stored therein. For example, one or more of the procedures described herein may be embodied by computer program instructions of a computer program product. In this regard, the computer program product(s) that embodies the procedures described herein may be stored by one or more memory devices (e.g., memory 212, memory 312, or memory 412) of a terminal apparatus, server, relay apparatus, or other computing device (e.g., the terminal apparatus 102) and executed by a processor (e.g., the processor 210, processor 310, or processor 410) in the computing device. In some embodiments, the computer program instructions comprising the computer program product(s) that embodies the procedures described above may be stored by memory devices of a plurality of computing devices. As will be appreciated, any such computer program product may be loaded onto a computer or other programmable apparatus to produce a machine, such that the computer program product including the instructions which execute on the computer or other programmable apparatus creates means for implementing the functions specified in the flowchart block(s).

Further, the computer program product may comprise one or more computer-readable memories on which the computer program instructions may be stored such that the one or more computer-readable memories can direct a computer or other programmable apparatus to function in a particular manner, such that the computer program product comprises an article of manufacture which implements the function specified in the flowchart block(s). The computer program instructions of one or more computer program products may also be loaded onto a computer or other programmable apparatus to cause a series of operations to be performed on the computer or other programmable apparatus to produce a computer-implemented process such that the instructions which execute on the computer or other programmable apparatus provide operations for implementing the functions specified in the flowchart block(s). Retrieval, loading, and execution of the program code instructions may be performed sequentially such that one instruction is retrieved, loaded, and executed at a time. In some example embodiments, retrieval, loading and/or execution may be performed in parallel such that multiple instructions are retrieved, loaded, and/or executed together.

Accordingly, execution of instructions associated with the operations of the flowchart by a processor, or storage of instructions associated with the blocks or operations of the flowchart in a computer-readable storage medium, supports combinations of operations for performing the specified functions. It will also be understood that one or more operations of the flowchart, and combinations of blocks or operations in the flowchart, may be implemented by special purpose hardware-based computer systems and/or processors which perform the specified functions, or combinations of special purpose hardware and program code instructions.

The above described functions may be carried out in many ways. For example, any suitable means for carrying out each of the functions described above may be employed to carry out embodiments of the invention. In one embodiment, a suitably configured processor (for example, the processor 210, processor 310, and/or processor 410) may provide all or a portion of the elements of the invention. In another embodiment, all or a portion of the elements of the invention may be configured by and operate under control of a computer program product. The computer program product for performing the methods of embodiments of the invention includes a computer-readable storage medium, such as the non-volatile storage medium (for example, the memory 212, memory 312, and/or memory 412), and computer-readable program code portions, such as a series of computer instructions, embodied in the computer-readable storage medium.

In an example embodiment, a method is provided, which may comprise providing for transmission of a request for a service. The method of this example embodiment may further comprise receiving a message comprising an ordered list of one or more entries for providing the service. Each entry may comprise one or more requirements associated with the entry. The method of this example embodiment may further comprise iteratively evaluating the one or more entries in the order specified by the ordered list. Evaluating a respective entry according to the method of this example embodiment may comprise determining one or more attributes related to the one or more requirements associated with the respective entry, and evaluating whether the one or more attributes satisfy the one or more requirements associated with the respective entry. The method may additionally comprise providing for delivery of the service as specified in an entry upon a determination that the one or more attributes satisfy the one or more requirements of the entry.

According to the example method, each of the one or more entries may comprise an indication of at least one of an application for providing the service and a method for delivering the service. Additionally, the one or more requirements associated with each of the one or more entries may correspond to the at least one of the application for providing the service and the method for delivering the service associated with the respective entry. Iteratively evaluating the one or more entries of the example method may further comprise terminating the iterative evaluation upon a determination that the one or more attributes satisfy the one or more requirements of an entry. According to the example method, providing for delivery of the service as specified in the entry may further comprise providing the service via the at least one of the application for providing the service and the method for delivering the service associated with the respective entry. The example method may further comprise restricting access to the service upon a determination that the one or more attributes do not satisfy the one or more requirements associated with any of the one or more entries. Providing for delivery of the service according to the example method may further comprise providing for delivery of the service via a web based portal. According to the example embodiment, receiving a message comprising an ordered list of one or more entries for providing the service may occur in response to a user selecting a service via the web based portal.

In another example embodiment, an apparatus comprising at least one processor and at least one memory storing computer program code is provided. The at least one memory and stored computer program code may be configured, with the at least one processor, to cause the apparatus of this example embodiment to at least provide for transmission of a request for a service. The at least one memory and stored computer program code may be configured, with the at least one processor, to further cause the apparatus of this example embodiment to receive a message comprising an ordered list of one or more entries for providing the service. Each entry may comprise one or more requirements associated with the entry. The at least one memory and stored computer program code may be configured, with the at least one processor, to additionally cause the apparatus of this example embodiment to iteratively evaluate the one or more entries in the order specified by the ordered list. Evaluating a respective entry according to the method of this example embodiment may comprise determining one or more attributes related to the one or more requirements associated with the respective entry, and evaluating whether the one or more attributes satisfy the one or more requirements associated with the respective entry. The at least one memory and stored computer program code may be configured, with the at least one processor, to further cause the apparatus of this example embodiment to provide for delivery of the service as specified in an entry upon a determination that the one or more attributes satisfy the one or more requirements of the entry.

According to the example embodiment, each of the one or more entries may comprise an indication of at least one of an application for providing the service and a method for delivering the service. Additionally, the one or more requirements associated with each of the one or more entries may correspond to the at least one of the application for providing the service and the method for delivering the service associated with the respective entry. Iteratively evaluating the one or more entries of the example method may further comprise terminating the iterative evaluation upon a determination that the one or more attributes satisfy the one or more requirements of an entry. According to the example embodiment, providing for delivery of the service as specified in the entry may further comprise providing the service via the at least one of the application for providing the service and the method for delivering the service associated with the respective entry. The at least one memory and stored computer program code may be configured, with the at least one processor, to additionally cause the apparatus of this example embodiment to restrict access to the service upon a determination that the one or more attributes do not satisfy the one or more requirements associated with any of the one or more entries. Providing for delivery of the service according to the example embodiment may further comprise providing for delivery of the service via a web based portal. According to the example embodiment, receiving a message comprising an ordered list of one or more entries for providing the service may occur in response to a user selecting a service via the web based portal.

In another example embodiment, a computer program product is provided. The computer program product of this example embodiment may include at least one computer-readable storage medium having computer-readable program instructions stored therein. The program instructions of this example embodiment may comprise program instructions configured to provide for transmission of a request for a service. The program instructions of this example embodiment may further comprise program instructions configured to receive a message comprising an ordered list of one or more entries for providing the service. Each entry may comprise one or more requirements associated with the entry. The program instructions of this example embodiment may additionally comprise program instructions configured to iteratively evaluate the one or more entries in the order specified by the ordered list. Evaluating a respective entry according to the method of this example embodiment may comprise determining one or more attributes related to the one or more requirements associated with the respective entry, and evaluating whether the one or more attributes satisfy the one or more requirements associated with the respective entry. The program instructions of this example embodiment may further comprise program instructions configured to provide for delivery of the service as specified in an entry upon a determination that the one or more attributes satisfy the one or more requirements of the entry.

According to the example embodiment, each of the one or more entries may comprise an indication of at least one of an application for providing the service and a method for delivering the service. Additionally, the one or more requirements associated with each of the one or more entries may correspond to the at least one of the application for providing the service and the method for delivering the service associated with the respective entry. Iteratively evaluating the one or more entries of the example method may further comprise terminating the iterative evaluation upon a determination that the one or more attributes satisfy the one or more requirements of an entry. According to the example embodiment, providing for delivery of the service as specified in the entry may further comprise providing the service via the at least one of the application for providing the service and the method for delivering the service associated with the respective entry. The program instructions of this example embodiment may additionally comprise program instructions configured to restrict access to the service upon a determination that the one or more attributes do not satisfy the one or more requirements associated with any of the one or more entries. Providing for delivery of the service according to the example embodiment may further comprise providing for delivery of the service via a web based portal. According to the example embodiment, receiving a message comprising an ordered list of one or more entries for providing the service may occur in response to a user selecting a service via the web based portal.

In another example embodiment, an apparatus is provided, which may comprise means for providing for transmission of a request for a service. The apparatus of this example embodiment may further comprise means for receiving a message comprising an ordered list of one or more entries for providing the service. Each entry may comprise one or more requirements associated with the entry. The apparatus of this example embodiment may additionally comprise means for iteratively evaluating the one or more entries in the order specified by the ordered list. Evaluating a respective entry according to the method of this example embodiment may comprise determining one or more attributes related to the one or more requirements associated with the respective entry, and evaluating whether the one or more attributes satisfy the one or more requirements associated with the respective entry. The apparatus of this example embodiment may additionally comprise means for providing for delivery of the service as specified in an entry upon a determination that the one or more attributes satisfy the one or more requirements of the entry.

According to the example embodiment, each of the one or more entries may comprise an indication of at least one of an application for providing the service and a method for delivering the service. Additionally, the one or more requirements associated with each of the one or more entries may correspond to the at least one of the application for providing the service and the method for delivering the service associated with the respective entry. Iteratively evaluating the one or more entries of the example method may further comprise terminating the iterative evaluation upon a determination that the one or more attributes satisfy the one or more requirements of an entry. According to the example embodiment, providing for delivery of the service as specified in the entry may further comprise providing the service via the at least one of the application for providing the service and the method for delivering the service associated with the respective entry. The apparatus of this example embodiment may additionally comprise means for restricting access to the service upon a determination that the one or more attributes do not satisfy the one or more requirements associated with any of the one or more entries. Providing for delivery of the service according to the example embodiment may further comprise providing for delivery of the service via a web based portal. According to the example embodiment, receiving a message comprising an ordered list of one or more entries for providing the service may occur in response to a user selecting a service via the web based portal.

In an example embodiment, a method is provided, which may comprise generating at least one ordered list of one or more entries for providing a respective service. Each entry may comprise one or more requirements associated with the entry. The method of this example embodiment may further comprise receiving a request for a service. The method of this example embodiment may further comprise providing for transmission of an ordered list associated with the requested service. Additionally, the method of this example embodiment may comprise receiving an indication of an entry of the ordered list. The method of this example embodiment may further comprise providing the service as specified in the entry.

According to the example embodiment, each of the one or more entries may comprise an indication of at least one of an application for providing the service and a method for delivering the service. The one or more requirements associated with each of the one or more entries of the example embodiment may correspond to the at least one application for providing the service and method for delivering the service associated with the respective entry. According to the example embodiment, providing the service as specified in the entry may further comprise providing the service via the at least one of the application for providing the service and the method for delivering the service associated with the respective entry. The example method may further comprise receiving one or more attributes related to the one or more requirements associated with the one or more entries of the at least one ordered list. Additionally, the example method may comprise evaluating whether the one or more attributes satisfy the one or more requirements for each of the one or more entries. The example method may further comprise removing an entry from a corresponding ordered list upon a determination that the one or more attributes do not satisfy the one or more requirements of the entry. Furthermore, the example method may comprise providing for storage of the at least one ordered list. According to the example embodiment, providing for transmission of the ordered list may further comprise retrieving the ordered list from storage, serializing the ordered list into a text string, and providing for transmission of the text string. Providing the service according to the example embodiment may further comprise providing the service via a web based portal.

In another example embodiment, an apparatus comprising at least one processor and at least one memory storing computer program code is provided. The at least one memory and stored computer program code may be configured, with the at least one processor, to cause the apparatus of this example embodiment to at least generate at least one ordered list of one or more entries for providing a respective service. Each entry may comprise one or more requirements associated with the entry. The at least one memory and stored computer program code may be configured, with the at least one processor, to further cause the apparatus of this example embodiment to receive a request for a service. The at least one memory and stored computer program code may be configured, with the at least one processor, to additionally cause the apparatus of this example embodiment to provide for transmission of an ordered list associated with the requested service. The at least one memory and stored computer program code may be configured, with the at least one processor, to further cause the apparatus of this example embodiment to receive an indication of an entry of the ordered list. The at least one memory and stored computer program code may be configured, with the at least one processor, to additionally cause the apparatus of this example embodiment to provide the service as specified in the entry.

According to the example embodiment, each of the one or more entries may comprise an indication of at least one of an application for providing the service and a method for delivering the service. The one or more requirements associated with each of the one or more entries of the example embodiment may correspond to the at least one application for providing the service and method for delivering the service associated with the respective entry. According to the example embodiment, providing the service as specified in the entry may further comprise providing the service via the at least one of the application for providing the service and the method for delivering the service associated with the respective entry. The at least one memory and stored computer program code may be configured, with the at least one processor, to additionally cause the apparatus of this example embodiment to receive one or more attributes related to the one or more requirements associated with the one or more entries of the at least one ordered list. Additionally, the at least one memory and stored computer program code may be configured, with the at least one processor, to cause the apparatus of this example embodiment to evaluate whether the one or more attributes satisfy the one or more requirements for each of the one or more entries. The at least one memory and stored computer program code may be configured, with the at least one processor, to additionally cause the apparatus of this example embodiment to remove an entry from a corresponding ordered list upon a determination that the one or more attributes do not satisfy the one or more requirements of the entry. Furthermore, the at least one memory and stored computer program code may be configured, with the at least one processor, to additionally cause the apparatus of this example embodiment to provide for storage of the at least one ordered list. According to the example embodiment, providing for transmission of the ordered list may further comprise retrieving the ordered list from storage, serializing the ordered list into a text string, and providing for transmission of the text string. Providing the service according to the example embodiment may further comprise providing the service via a web based portal.

In another example embodiment, a computer program product is provided. The computer program product of this example embodiment may include at least one computer-readable storage medium having computer-readable program instructions stored therein. The program instructions of this example embodiment may comprise program instructions configured to generate at least one ordered list of one or more entries for providing a respective service. Each entry may comprise one or more requirements associated with the entry. The program instructions of this example embodiment may further comprise program instructions configured to receive a request for a service. The program instructions of this example embodiment may additionally comprise program instructions configured to provide for transmission of an ordered list associated with the requested service. The program instructions of this example embodiment may further comprise program instructions configured to receive an indication of an entry of the ordered list. The program instructions of this example embodiment may additionally comprise program instructions configured to provide the service as specified in the entry.

According to the example embodiment, each of the one or more entries may comprise an indication of at least one of an application for providing the service and a method for delivering the service. The one or more requirements associated with each of the one or more entries of the example embodiment may correspond to the at least one application for providing the service and method for delivering the service associated with the respective entry. According to the example embodiment, providing the service as specified in the entry may further comprise providing the service via the at least one of the application for providing the service and the method for delivering the service associated with the respective entry. The program instructions of this example embodiment may further comprise program instructions configured to receive one or more attributes related to the one or more requirements associated with the one or more entries of the at least one ordered list. Additionally, the program instructions of this example embodiment may comprise program instructions configured to evaluate whether the one or more attributes satisfy the one or more requirements for each of the one or more entries. The program instructions of this example embodiment may further comprise program instructions configured to remove an entry from a corresponding ordered list upon a determination that the one or more attributes do not satisfy the one or more requirements of the entry. Furthermore, the program instructions of this example embodiment may comprise program instructions configured to provide for storage of the at least one ordered list. According to the example embodiment, providing for transmission of the ordered list may further comprise retrieving the ordered list from storage, serializing the ordered list into a text string, and providing for transmission of the text string. Providing the service according to the example embodiment may further comprise providing the service via a web based portal.

In another example embodiment, an apparatus is provided, which may comprise means for generating at least one ordered list of one or more entries for providing a respective service. Each entry may comprise one or more requirements associated with the entry. The apparatus of this example embodiment may further comprise means for receiving a request for a service. The apparatus of this example embodiment may additionally comprise means for providing for transmission of an ordered list associated with the requested service. The apparatus of this example embodiment may further comprise means for receiving an indication of an entry of the ordered list. The apparatus of this example embodiment may additionally comprise means for providing the service as specified in the entry.

According to the example embodiment, each of the one or more entries may comprise an indication of at least one of an application for providing the service and a method for delivering the service. The one or more requirements associated with each of the one or more entries of the example embodiment may correspond to the at least one application for providing the service and method for delivering the service associated with the respective entry. According to the example embodiment, providing the service as specified in the entry may further comprise providing the service via the at least one of the application for providing the service and the method for delivering the service associated with the respective entry. The apparatus of this example embodiment may further comprise means for receiving one or more attributes related to the one or more requirements associated with the one or more entries of the at least one ordered list. Additionally, the apparatus of this example embodiment may comprise means for evaluating whether the one or more attributes satisfy the one or more requirements for each of the one or more entries. The apparatus of this example embodiment may further comprise means for removing an entry from a corresponding ordered list upon a determination that the one or more attributes do not satisfy the one or more requirements of the entry. Furthermore, the apparatus of this example embodiment may comprise means for providing for storage of the at least one ordered list. According to the example embodiment, providing for transmission of the ordered list may further comprise retrieving the ordered list from storage, serializing the ordered list into a text string, and providing for transmission of the text string. Providing the service according to the example embodiment may further comprise providing the service via a web based portal.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions other than those explicitly described above are also contemplated as may be set forth in some of the appended claims. Although specific terms are employed herein, they are used in a generic and descriptive sense only and not for purposes of limitation.

That which is claimed is:

1. A method for receiving one or more services for a terminal apparatus, which method comprises:
transmitting a request for a service;
receiving a message comprising an ordered list of one or more entries for providing the service, wherein each entry comprises one or more requirements associated with the entry;
iteratively evaluating the one or more entries in the order specified by the ordered list by,
determining one or more attributes associated with the terminal apparatus related to the one or more requirements associated with the respective entry, and
evaluating whether the one or more attributes satisfy the one or more requirements associated with the respective entry, and
receiving delivery of the service as specified in an entry upon a determination that the one or more attributes satisfy the one or more requirements of the entry.

2. The method of claim 1 wherein the step of receiving a message further comprises receiving a message wherein each of the one or more entries comprises at least an indication of at least one of an application for providing the service and a method for delivering the service.

3. The method of claim 2 wherein the step of receiving a message further comprises receiving a message wherein each of the one or more entries corresponds to the at least one of the application for providing the service and the method for delivering the service associated with the respective entry.

4. The method of claim 3 wherein the step of receiving delivery of the service further comprises receiving the service via the at least one of the application for providing the service and the method for delivering the service associated with the respective entry.

5. The method of claim 1 wherein the step of iteratively evaluating the one or more entries further comprises terminating the iterative evaluation upon a determination that the one or more attributes satisfy the one or more requirements of an entry.

6. The method of claim 5 further comprising restricting access to a service upon a determination that the one or more attributes do not satisfy the one or more requirements associated with any of the one or more entries.

7. The method of claim 1 wherein the step of receiving the delivery of the service further comprises receiving delivery of the service via a web based portal.

8. The method of claim 7 wherein the step of receiving a message comprising an ordered list of one or more entries for providing the service occurs in response to a user selecting a service via the web based portal.

9. An apparatus for receiving one or more services, the apparatus comprising:
at least one processor;
at least one memory storing computer program code; and
wherein the at least one memory and stored computer program code are configured, with the at least one processor, to cause the apparatus to,
transmit a request for a service,
receive a message comprising an ordered list of one or more entries for providing the service, wherein each entry comprises one or more requirements associated with the entry,
iteratively evaluate the one or more entries in the order specified by the ordered list by,
determining one or more attributes associated with the terminal apparatus related to the one or more requirements associated with the respective entry, and
evaluating whether the one or more attributes satisfy the one or more requirements associated with the respective entry, and
receive delivery of the service as specified in an entry upon a determination that the one or more attributes satisfy the one or more requirements of the entry.

10. The apparatus of claim 9 wherein the at least one memory and at least one stored computer program code are configured, with the at least one processor, to further cause the apparatus to receive an indication of at least one of an application for providing the service and a method for delivering the service.

11. The apparatus of claim 10 wherein the at least one memory and at least one stored computer program code are configured, with the at least one processor, to further cause the apparatus to receive a message wherein each of the one or more requirements associated with each of the one or more entries corresponds to the at least one of the application for providing the service and the method for delivering the service associated with the respective entry.

12. The apparatus of claim 11 wherein the at least one memory and at least one stored computer program code are configured, with the at least one processor, to further cause receiving the service via the at least one of the application for providing the service and the method for delivering the service associated with the respective entry.

13. The apparatus of claim 9 wherein the at least one memory and at least one stored computer program code are configured, with the at least one processor, to terminate the iterative evaluation upon a determination that the one or more attributes satisfy the one or more requirements of an entry.

14. The apparatus of claim 13 wherein the at least one memory and at least one stored computer program code are configured, with the at least one processor, to restrict access to the service upon a determination that the one or more attributes do not satisfy the one or more requirements associated with any of the one or more entries.

15. The apparatus of claim 13 wherein the at least one memory and at least one stored computer program code are configured, with the at least one processor, to receive delivery of the service via a web based portal.

16. The apparatus of claim 15 wherein the at least one memory and at least one stored computer program code are configured, with the at least one processor, to receive a message comprising an ordered list of one or more entries for providing the service in response to a user selecting a service via the web based portal.

17. A computer program product for providing for delivery of one or more services, the computer program product comprising:
at least one computer-readable storage medium having computer-readable program instructions stored therein, the program instructions configured to,
provide for transmission of a request for a service,
receive a message comprising an ordered list of one or more entries for providing the service, wherein each entry comprises one or more requirements associated with the entry,
iteratively evaluate the one or more entries in the order specified by the ordered list, by
determining one or more attributes related to the one or more requirements associated with the respective entry, and,
evaluating whether the one or more attributes satisfy the one or more requirements associated with the respective entry, and
provide for delivery of the service as specified in an entry upon a determination that the one or more attributes satisfy the one or more requirements of the entry.

18. The computer program product of claim 17 wherein the program instructions are further configured to receive a message wherein each of the one or more entries comprises at least an indication of at least one of an application for providing the service and a method for delivering the service.

19. The computer program production of claim 18 wherein the program instructions are further configured to receive a message wherein each of the one or more entries corresponds to the at least one of the application for providing the service and the method for delivering the service associated with the respective entry.

20. The computer program product of claim 19 wherein the program instructions are further configured to receive the service via the at least one of the application for providing the service and the method for delivering the service associated with the respective entry.

21. The computer program product of claim 20 wherein the program instructions are further configured to terminate the iterative evaluation upon a determination that the one or more attributes satisfy the one or more requirements of an entry.

22. The computer program product of claim 21 wherein the program instructions are further configured to restrict access to a service upon a determination that the one or more attributes do not satisfy the one or more requirements associated with any of the one or more entries.

23. The computer program product of claim 17 wherein the program instructions are further configured to receive delivery of the service via a web based portal.

24. The computer program product of claim 23 wherein the program instructions are further configured to receive the message comprising an ordered list of one or more entries for providing the service in response to a user selecting a service via the web based portal.

25. A method for providing one or more services for a terminal apparatus, which method comprises:
generating at least one ordered list of one or more entries for providing a respective service, wherein each entry comprises one or more requirements associated with the entry;
receiving a request for a service;
transmitting an ordered list associated with the requested service;
receiving an indication of an entry of the ordered list; and
providing the service as specified in the entry.

26. The method of claim 25 further comprising the step of storing the at least one ordered list.

27. The method of claim 26 further comprising the steps of retrieving the ordered list from storage, serializing the ordered list into a text string, and providing for transmission of the text string.
